(19) United States
(12) Patent Application Publication
(10) Pub. No.: US 2026/0192383 A1
(43) Pub. Date: Jul. 9, 2026

(54) POROUS SUPPORT LASER PROCESSING SYSTEM

(71) Applicant: K2 LASER SYSTEM INC., Anyang-si (KR)

(72) Inventors: Myeong Soo KIM, Anyang-si (KR); Yeoungcheol KIM, Anyang-si (KR); Ko Dong PARK, Anyang-si (KR); Yo Han CHO, Anyang-si (KR); Jooho JUNG, Anyang-si (KR); Jae Hyok KIM, Anyang-si (KR)

(21) Appl. No.: 19/251,641

(22) Filed: Jun. 26, 2025

(30) Foreign Application Priority Data
Jan. 6, 2025 (KR) 10-2025-0001338
Jun. 19, 2025 (KR) 10-2025-0080764

(51) Int. Cl. B23K 26/0622; B23K 26/082; B23K 37/04

(52) U.S. Cl. CPC B23K 26/0622; B23K 26/082; B23K 37/04

(57) ABSTRACT

The present invention relates to a porous support laser processing system and aims to provide a high-speed laser processing system that optimizes laser pulse control and high-speed movement of a scanner to prevent processing delay or non-uniform pulse distribution due to acceleration and deceleration and maintain constant spacing between holes. To that end, the present invention discloses a porous support laser processing system comprising a laser source outputting a laser beam having a pulse repetition frequency; a scanner receiving the laser beam from the laser source and reflecting and irradiating the laser beam to a porous support; and a controller integrally controlling the laser source and the scanner, wherein the controller controls the laser source and the scanner such that the pulse repetition frequency of the laser source and a moving speed of the scanner are synchronized based on a ratio to form a plurality of holes with constant spacing, constant width, and constant depth in the porous support.

### CROSS-REFERENCE TO RELATED APPLICATION(S)

This application claims priority to Korean Patent Application Nos. 10-2025-0001338, filed on Jan. 6, 2025, and 10-2025-0080764, filed on Jun. 19, 2025 in the Korean Intellectual Property Office, the disclosures of which are incorporated by reference herein in their entireties.

### TECHNICAL FIELD

The present invention relates to a laser processing system, and more particularly, to a laser processing system capable of processing a porous support at high speed.

### DISCUSSION OF RELATED ART

High-precision micro drilling technology is used as an essential technology in manufacturing industries such as fuel cell supports and porous metal filters. Conventional laser processing systems have limitations in controlling laser pulse control and high-speed movement of a scanner. This causes processing delay or non-uniform pulse distribution due to acceleration and deceleration, which may deteriorate processing quality.

The description disclosed in the Background section is only for a better understanding of the background of the invention and may also include information which does not constitute the prior art.

### SUMMARY

The present invention aims to provide a high-speed laser processing system that optimizes laser pulse control and high-speed movement of a scanner to prevent processing delay or non-uniform pulse distribution due to acceleration and deceleration and maintain constant spacing between holes.

A porous support laser processing system according to the present invention includes: a laser source outputting a laser beam having a pulse repetition frequency; a scanner receiving the laser beam from the laser source and reflecting and irradiating the laser beam to a porous support; and a controller integrally controlling the laser source and the scanner, wherein the controller controls the laser source and the scanner such that the pulse repetition frequency of the laser source and a moving speed of the scanner are synchronized based on a ratio to form a plurality of holes with constant spacing, constant width, and constant depth in the porous support.

In one or more embodiments, the system further includes a beam splitter, and the beam splitter distributes the laser beam received from the laser source to multiple paths and delivers the distributed laser beam to the scanner.

In one or more embodiments, the system further includes a vision unit, and the vision unit captures a surface of the porous support in real-time, synthesizes the captured surface into a whole image, automatically adjusts a position such that a drilling pattern is aligned with a center of the support, and feeds back processing position and alignment information to the controller.

In one or more embodiments, the system further includes a synchronization monitoring unit that senses a portion of the laser beam from each of the laser source and the scanner and monitors the pulse repetition frequency of the laser source and the moving speed of the scanner in real-time, and the controller integrally controls the laser source, the scanner, and the synchronization monitoring unit, and controls the laser source and the scanner such that the pulse repetition frequency of the laser source and the moving speed of the scanner are synchronized based on a synchronization monitoring signal received from the synchronization monitoring unit.

In one or more embodiments, the system further includes a processing monitoring unit, and the processing monitoring unit measures a hole processing depth and a hole shape of the porous support in real-time and feeds back the measured depth and shape to the controller.

In one or more embodiments, the processing monitoring unit may include an optical coherence tomography (OCT) or a chromatic confocal device.

In one or more embodiments, the controller controls the laser source and the scanner based on a feedback signal to make the processing depth of the hole and the shape of the hole constant.

In one or more embodiments, the system further includes a suction jig unit, and the suction jig unit includes: a suction jig fixing the porous support; a blower installed on one side of the suction jig and blowing away scattered particles generated during processing; and a discharge unit installed on another side of the suction jig and sucking the scattered particles and discharging the scattered particles to the outside.

In one or more embodiments, the controller controls the scanner to perform at least one of multi-path processing, processing direction, processing sequence, processing division, line spacing, and distance adjustment for the porous support, wherein the multi-path processing is such that the controller controls the scanner to disperse energy of the laser beam to a work area and performs gradual etching through multiple paths to prevent material deformation, the processing direction is such that the controller controls a moving path of the scanner and a moving direction of the laser beam to increase processing efficiency through bi-directional or unidirectional scanning, the processing sequence is such that the controller sets a processing sequence of the scanner to a raster pattern or an interlacing scanning method to adjust processing speed and precision, the processing division is such that the controller equally divides a work area of the scanner into uniform area units to proceed with processing and reduces time required for movement of the scanner, the line spacing is such that the controller adjusts spacing between pulses of the laser beam by the laser source and spacing between lines by the scanner to adjust pattern density and changes a rectangular arrangement to a diamond or hexagonal pattern, and the distance adjustment is such that the controller periodically adjusts a distance between the scanner and the porous support when performing the multi-path processing to adjust a focus of a Gaussian beam.

A laser processing system according to the present invention synchronizes a scanner moving at high speed and pulse control to prevent processing delay due to acceleration and deceleration and match laser pulse spacing with drilling hole spacing.

Further, the laser processing system according to the present invention may control the pulse repetition frequency in real-time based on the ratio according to scanner speed changes without fixing the pulse repetition frequency (PRF) or relying on external triggers, so that hole spacing is uniformly maintained throughout all sections during processing.

Further, the laser processing system according to the present invention provides economic efficiency compared to expensive ultrashort pulse lasers when controlled in synchronization with external triggers that trigger laser pulses, and enables efficient processing in a wider range using nanosecond lasers.

### BRIEF DESCRIPTION OF THE DRAWINGS

FIG. 1 is a block diagram illustrating a configuration of a porous support laser processing system according to the present invention.

FIG. 2 is a waveform diagram for time synchronization of a porous support laser processing system according to the present invention.

FIG. 3 is a view illustrating an example of a working method by a porous support laser processing system according to the present invention.

FIG. 4 is a view illustrating an example of a working method by a porous support laser processing system according to the present invention.

FIG. 5 is a view illustrating an example of a working method by a porous support laser processing system according to the present invention.

FIG. 6 is a view illustrating an example of a working method by a porous support laser processing system according to the present invention.

### DETAILED DESCRIPTION

Hereinafter, embodiments of the present invention are described in detail with reference to the accompanying drawings.

The present invention is provided to more completely describe the present invention to those skilled in the art, and the following embodiments may be modified in various different forms, and the scope of the present invention is not limited to the following embodiments. Embodiments of the disclosure are provided to fully and thoroughly convey the spirit of the present invention to those skilled in the art.

As used herein, the thickness and size of each layer may be exaggerated for ease or clarity of description. The same reference denotations may be used to refer to the same or substantially the same elements throughout the specification and the drawings. As used herein, the term “A and/or B” encompasses any, or one or more combinations, of A and B. It will be understood that when an element or layer is referred to as being “on,” “connected to,” “coupled to,” or “adjacent to” another element or layer, it can be directly on, connected, coupled, or adjacent to the other element or layer, or intervening elements or layers may be present.

The terms as used herein are provided merely to describe some embodiments thereof, but not intended as limiting the present invention. As used herein, the singular forms “a,” “an,” and “the” are intended to include the plural forms as well, unless the context clearly indicates otherwise. As used herein, the term “comprise,” “include,” and/or “comprising” or “including” does not exclude the presence or addition of one or more other components, steps, operations, and/or elements than the component, step, operation, and/or element already mentioned.

As used herein, the terms “first” and “second” may be used to describe various members, parts, regions, areas, layers, and/or portions, but the members, parts, regions, areas, layers, and/or portions are not limited thereby. These terms are used merely to distinguish one member, part, region, area, layer, or portion from another. Accordingly, the term “first member,” “first part,” “first region,” “first area,” “first layer,” or “first portion” described herein may denote a “second member,” “second part,” “second region,” “second area,” “second layer,” or “second portion” without departing from the teachings disclosed herein.

The terms “beneath,” “below,” “lower,” “under,” “above,” “upper,” “on,” or other terms to indicate a position or location may be used for a better understanding of the relation between an element or feature and another as shown in the drawings. However, embodiments of the present invention are not limited thereby or thereto. For example, where a lower element or an element positioned under another element is overturned, then the element may be termed as an upper element or element positioned above the other element. Thus, the term “under” or “beneath” may encompass, in meaning, the term “above” or “over.”

As described herein, the controller and/or other related devices or parts may be implemented in hardware, firmware, application specific integrated circuits (ASICs), software, or a combination thereof. For example, the controller and/or other related devices or parts or its or their components may be implemented in a single integrated circuit (IC) chip or individually in multiple IC chips. Further, various components of the controller may be implemented on a flexible printed circuit board, in a tape carrier package, on a printed circuit board, or on the same substrate as the controller. Further, various components of the controller may be processes, threads, operations, instructions, or commands executed on one or more processors in one or more computing devices, which may execute computer programming instructions or commands to perform various functions described herein and interwork with other components. The computer programming instructions or commands may be stored in a memory to be executable on a computing device using a standard memory device, e.g., a random access memory (RAM). The computer programming instructions or commands may be stored in, e.g., a compact-disc read only memory (CD-ROM), flash drive, or other non-transitory computer readable media. It will be appreciated by one of ordinary skill in the art that various functions of the computing device may be combined together or into a single computing device or particular functions of a computing device may be distributed to one or other computing devices without departing from the scope of the present invention.

As an example, the controller of the present invention may be operated on a typical commercial computer including a central processing unit, a hard disk drive (HDD) or solid state drive (SSD) or other high-volume storage, a volatile memory device, a keyboard, mouse, or other input devices, and a monitor, printer, or other output devices.

Generally, high-precision micro drilling is actively used in various manufacturing industries such as fuel cell supports and porous metal filters due to excellent processing quality and economic efficiency. This is particularly important in fields requiring very precise perforation.

The present invention aims for ultra-high speed surface processing and provides a system combining a laser source and scanner with high pulse repetition frequency (PRF) and output. This system enables precise processing by combining a scanner moving at high speed with laser pulse control.

A scanner inevitably undergoes acceleration and deceleration due to motor inertia. However, this system performs processing only with laser pulse control, optimizing processing using the proportional relationship between scanner movement speed and pulse frequency. This prevents processing delay due to acceleration and deceleration and prevents non-uniform pulse distribution and local excessive processing. In other words, the spacing between holes is maintained constant.

This system uses a laser source with the pulse on demand (POD) function. The POD function is synchronized with external triggers to enable triggering of laser pulses only at necessary moments, allowing precise pulse control. Further, an acousto-optic modulator (AOM) based pulse picker method may be used. However, since this function is mainly applied to ultrashort pulse lasers, it is not efficient in processes using nanosecond lasers.

Therefore, the present invention provides a synchronization monitoring unit to verify whether laser pulse spacing and drilling hole spacing match, using a nanosecond laser source and scanner as the basic configuration. This monitoring unit controls laser pulses and the spacing between holes to be precisely matched.

A pulse laser is mainly used for processing fine patterns and structures in thin film or thin plate materials. A pulse laser may increase the energy absorption rate for materials and reduce unwanted deformation due to thermal effects, making it very suitable for thin plate material processing. Due to these characteristics, multiple fine hole patterns may be uniformly processed on metal plates for fuel cell manufacturing. It is also utilized in substrate processing used for touch screens or position sensors.

The present invention combines a laser source with high frequency pulses and high output and a scanner for high-speed surface processing to prevent processing delay and non-uniform pulse distribution due to scanner movement. Through laser pulse control and a synchronization monitoring unit, the spacing between holes is maintained constant, and efficient processing is provided based on a nanosecond laser source and scanner. This system may be applied to various industries requiring high-precision micro drilling, which is described below in detail.

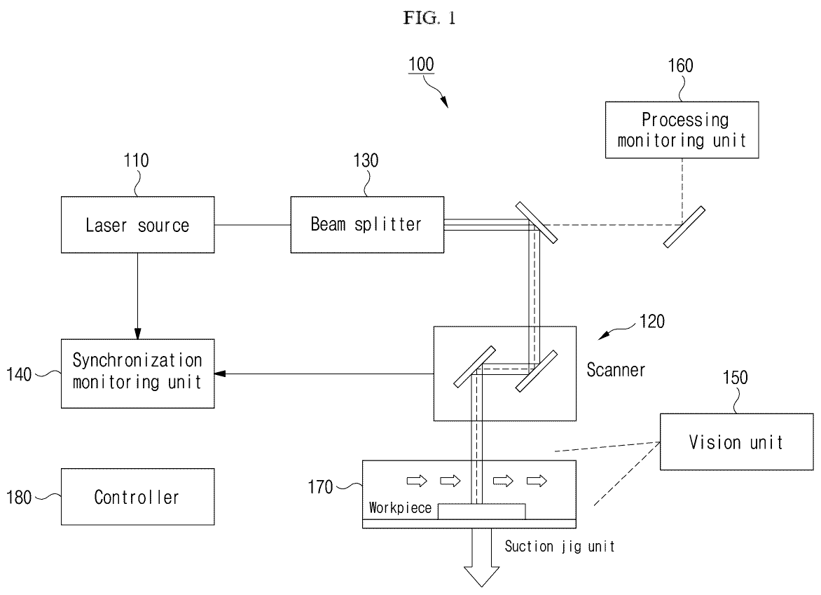

FIG. 1 is a block diagram illustrating a configuration of a porous support laser processing system 100 according to the present invention. As illustrated in FIG. 1, the laser processing system 100 according to the present invention includes a laser source 110, a scanner 120, and a controller 180, and may further include at least one of a beam splitter 130, a synchronization monitoring unit 140, a vision unit 150, a processing monitoring unit 160, and a suction jig unit 170.

The laser source 110 may generate laser pulses. A laser pulse may generate light that emits high energy during a high-speed short time, and such light is necessary for high-precision micro drilling or surface processing.

The laser source 110 may generate laser beams with various wavelengths and may generally use wavelength ranges from UV (ultraviolet) to NIR (near-infrared). Major wavelengths include 266 nm, 355 nm, 532 nm, 1064 nm, etc., which may be wavelengths suitable for processing specific materials respectively.

266 nm: Ultraviolet, suitable for very precise processing

355 nm: Ultraviolet, suitable for surface treatment and fine processing 532 nm: Visible light, suitable for surface processing of metals and ceramics

1064 nm: Near-infrared, widely used for metal processing

Meanwhile, the laser source 110 may adjust the pulse repetition frequency (PRF) to select an optimal frequency suitable for processing conditions. PRF means the frequency at which laser pulses are emitted, and this value may greatly affect laser processing speed and quality.

The laser source 110 may also emit high pulse energy at kW and J levels, enabling efficient delivery of large amounts of energy to processing at high speed. This high energy is advantageous for processing high-strength materials such as porous materials.

Further, the spot diameter of a laser beam is the size of the area where laser light is concentrated on the surface being processed, and may be determined according to the quality and focal length of the laser beam.

For example, the spot diameter may be calculated through the following [Equation 1].

$${d}_{f} = \frac{4 \cdot f \cdot λ \cdot {M}^{2}}{{d}_{0} \cdot π} \qquad [ Equation 1 ]$$

λ: laser wavelength (representing the length of a given wavelength)
M²: beam quality (a numerical value representing the quality of a laser beam, with ideal beam quality being M²=1)
f: focal length (distance where a laser beam is focused)
d₀: diameter of an incident beam (diameter of an incident laser beam in a Gaussian beam model)
d_{f}: spot diameter at focus (size of a beam reaching a processing area)

Through the formula, the size of a laser beam at focus may be calculated, and through this, a beam may be optimized to achieve high-precision processing. Since the spot diameter directly affects processing accuracy, it is important to appropriately adjust each parameter.

Such a laser source 110 may operate in the order of laser beam generation, pulse control, and laser beam movement and processing.

In one or more embodiments, light in the laser source 110 may be amplified by a laser medium (solid, gas, liquid, etc.) through electromagnetic shock. Photons generated in this process may be output in pulse form. A laser pulse may be generated by concentrating high-output energy during a short time.

Further, the laser source 110 may control pulses to output a laser beam with constant period and energy. The length and spacing of pulses and energy may be dynamically adjusted by a control system of the laser source 110. Accordingly, necessary processing speed and precision may be matched. The PRF and wavelength of a laser beam may be optimized according to specific processing tasks. For example, high PRF may be used when fast processing is needed, and low PRF and longer pulses may be used for precise processing.

Further, a laser beam may scan a processing surface in synchronization with the scanner 120. By optimizing focal length and spot size, laser energy may be accurately delivered to desired positions. Thanks to synchronization with the scanner 120, laser pulses scan a surface at high speed and may perform precise processing by accurately reaching necessary positions.

The laser source 110 provides high-output pulsed lasers with various wavelengths and variable PRF, enabling high-speed and high-precision processing. Further, by precisely calculating the spot size, optimal processing quality is maintained, and pulse control suitable for the characteristics of materials being processed is achieved. Due to these characteristics, the porous support laser processing system 100 according to the present invention may realize precise laser processing of porous supports or high-strength materials in various industrial fields.

The scanner 120 may include a Galvano motor or polygon mirror, a focus lens, and a protective window or plate.

Using a Galvano motor or polygon type mirror, the scanner 120 may accurately steer a laser beam to desired positions. A Galvano motor is frequently used in processing requiring high precision and may control the path of a laser beam through two rotatable mirrors. A Galvano system is generally slow in speed but may be controlled very precisely, making it suitable for fine processing. A polygon mirror helps a polygonal mirror rotate to quickly scan a laser beam. A polygon mirror enables much faster high-speed linear scanning than a Galvano scanner, but has constraints in path flexibility, which may be disadvantageous for processing complex patterns.

A focus lens enables the scanner 120 to focus a laser beam and accurately focus on a surface to be processed. A focus lens focuses a beam to deliver large energy to a small area, enabling very precise processing. A lens should be configured to maintain constant beam focus size while performing high-speed scanning. This is an important factor determining processing quality.

A protective window or plate may serve to prevent contamination by scattered particles rising from a lower chamber. This protective device serves to protect the scanner 120 and the optical system and may safely protect a laser system from dust or debris that may occur during processing. A protective device should be configured not to affect the accuracy and quality of a laser beam and should be durable for long-term use.

The performance of such a scanner 120 is an important factor determining overall processing speed and flexibility. For high-speed processing, the scanner 120 should be able to move quickly, but this speed and flexibility may depend on the configuration and performance of the scanner 120. For example, a Galvano scanner provides high accuracy but has relatively slow speed, so it may have limitations in mass processing. Further, since the scanner 120 should place a pulse beam at accurate positions, position accuracy is very important. The movement path of the scanner 120 should be precisely controlled so that a laser beam accurately reaches desired positions. The better the performance of the scanner 120, the higher the position accuracy of a pulse beam, enabling more precise processing. Further, a polygon mirror enables high-speed linear scanning but has constraints in path flexibility, so it may be less advantageous for processing complex shapes. On the other hand, a Galvano motor enables accurate position control but may have limitations in high-speed processing. Therefore, the selection of the scanner 120 mainly varies according to shapes to be processed and required speed.

The scanner 120 is an important device that moves a laser beam quickly and accurately. Since the Galvano scanners 120 and polygon mirrors each have advantages and disadvantages in high-speed and precise processing, it is important to select an appropriate system according to necessary processing. Further, a focus lens and protective device are added to help achieve accurate and safe processing. All these components may be combined to provide an optimal laser processing system 100.

The controller 180 plays a very important role in the laser processing system 100 according to the present invention and may integrally control various components as is described below. The controller 180 controls the laser source 110 and the scanner 120 such that the pulse repetition frequency of the laser source 110 and the moving speed of the scanner 120 are synchronized to form holes with constant spacing, constant width, and constant depth in the porous support.

In this case, the controller 180 may i) control the pulse repetition frequency of the laser source 110 and the moving speed of the scanner 120 to be synchronized through ratio-based control of the moving speed of the scanner 120 versus pulse repetition frequency, or ii) control the laser source 110 and the scanner 120 such that the pulse repetition frequency of the laser source 110 and the moving speed of the scanner 120 are synchronized based on a synchronization monitoring signal received from the synchronization monitoring unit 140. Since the spacing between holes is the moving speed of the scanner 120/pulse repetition frequency, if the moving speed of the scanner 120 and pulse repetition frequency are controlled to increase and decrease at the same ratio based on the ratio, the spacing between holes may be maintained constant.

The beam splitter 130 distributes a laser beam received from the laser source to multiple paths and delivers the distributed beam to the scanner. In other words, the beam splitter 130 divides one laser beam into multiple small beams to help processing be performed simultaneously at multiple positions. In this case, a multiple array may provide a method of dividing a beam into multiple small beams. This method may extend the processing range by dividing one laser beam into various numbers of small beams and maximize the number of hole processing per unit area. Using a multiple array, multiple laser beams may simultaneously process at different positions, so processing speed becomes faster and efficiency increases.

A splitting method by the beam splitter 130 may include diffractive optical element (DOE) and birefringence.

DOE is an optical component that may precisely control a laser beam to split it into multiple beams. DOE may divide a beam into specific patterns and accurately steer each beam to desired positions. Accordingly, one laser beam may be divided into multiple small beams to simultaneously drill multiple holes with one laser shot. DOE is particularly useful when reducing the size and pattern spacing of through holes. For example, it is suitable for quickly drilling small holes at constant spacing for high-precision processing.

Birefringence is a method of dividing a laser beam into two or more paths using the property that a material has two different beam paths. Using the birefringence effect, one laser beam may be divided into two or more beams at different angles for processing. This method may mainly be used to create more complex patterns by splitting a beam into multiple beams or to process multiple tasks simultaneously.

Meanwhile, the beam splitter 130 and the scanner 120 may be combined with each other. In other words, split laser beams may be steered to specific positions on a processing plane by the scanner 120. The scanner 120 may control the path of each beam while moving at high speed to accurately align laser beams to processing surfaces. Multiple split beams simultaneously move to different positions on processing surfaces and may drill multiple holes simultaneously or create complex patterns. The scanner 120 precisely controls beam movement and helps each beam accurately perform work at specific positions. In this process, the high-speed movement capability and accurate synchronization of the scanner 120 are important.

The beam splitter 130 may increase the efficiency of hole processing. In other words, by splitting one laser beam into multiple small beams, the number of hole processing per unit area may be maximized. This efficiently covers the processing area and speeds up processing to shorten overall processing time. The beam splitter 130 also enables precise pattern formation. Using methods such as DOE or birefringence, fine through holes may be decreased at constant spacing to form precise patterns. This method is advantageous particularly in high-precision processing requiring high-density patterns. The beam splitter 130 enables simultaneous multiple processing. In other words, using the beam splitter 130, multiple laser beams may be simultaneously delivered to multiple positions to enable simultaneous multiple processing. Multiple holes may be drilled simultaneously or complex patterns may be processed simultaneously, greatly reducing overall processing time. Further, the beam splitter 130 enables high-speed processing. In other words, since multiple beams may be used simultaneously, high-speed processing becomes possible. This is a very important advantage in mass production, greatly enhancing processing efficiency.

As such, the beam splitter 130 divides one laser beam into multiple beams to enable processing to be performed simultaneously at multiple positions. Using DOE or birefringence methods, precise pattern formation and fast processing are possible, and the number of processing per unit area may be maximized. Further, by combining with the scanner 120, split beams are helped to accurately reach desired positions, enabling high-speed multiple processing to increase overall processing efficiency.

The synchronization monitoring unit 140 may function as maintaining constant spacing between holes and accurately synchronizing with movement of the scanner 120 when the laser processing system 100 performs drilling using pulse trains. It maximizes the precision of pulse train-based processing and ensures constant quality even in high-speed environments through real-time synchronization maintenance and energy uniformity. The synchronization monitoring unit 140 may include at least one of a pulse train, a photodiode (PD) sensor, a high-speed amplifier and integrator, and an analog-digital converter.

A pulse train is a form in which multiple laser pulses occur continuously at constant time intervals. The time interval between each pulse may match the spatial spacing between holes. In other words, if pulse spacing is maintained constant, the spacing between holes may be formed uniformly. Using this characteristic, precise micro drilling work may be performed. The spacing between pulses is very important for maintaining uniform spacing between holes in laser processing. To that end, the rotation speed of the scanner 120 and the generation interval of laser pulses should be precisely synchronized.

A beam splitting device may serve to split a portion of laser beams emitted from the laser source 110 and the scanner 120 and deliver them to the synchronization monitoring unit 140, and may be designed according to polarization, wavelength, output characteristics, etc., and may generally be disposed on a path before the scanner 120. Various methods may be used for beam splitting. In one or more embodiments, a partially transmissive mirror that divides a beam at a predetermined ratio and delivers only a portion to the synchronization monitoring unit 140 may be used. In one or more embodiments, a polarizing lens that separates some beams using the polarization state of a laser beam may be used. In one or more embodiments, laser beams may be divided using different wavelength bands. In one or more embodiments, peak output filtering that separates only desired portions of beams using output characteristics of laser pulses may be used.

The PD sensor may sense split beams. The PD sensor may serve to convert laser pulses into electrical current. This converted electrical signal may be analyzed in the controller 180 and used to identify the timing of pulses or synchronization state. Values measured by the PD sensor may be used to determine synchronization between pulse energy and scan signals.

The high-speed amplifier and integrator may amplify signals converted from the PD sensor and obtain average values through an integrator. This process is useful for accurately measuring energy or timing of pulses and monitoring synchronization in real-time.

The analog-digital converter may convert amplified analog signals into digital signals. Digital signals are input to the controller 180 to identify synchronization state or timing of pulses in real-time.

The synchronization monitoring unit 140 with such configuration first synchronizes the pulse train and the scanner 120. In other words, in drilling using a pulse train, the spacing between each laser pulse may determine the spacing between holes. To maintain this constantly, the pulse spacing of the laser source 110 and the movement speed of the scanner 120 should be precisely synchronized. The synchronization monitoring unit 140 may monitor in real-time so that pulse spacing and the speed of the scanner 120 match. In this process, if the rotation speed of the scanner 120 is set correctly and time spacing between pulse trains is accurately maintained, the spacing between holes may be maintained uniformly.

Further, the synchronization monitoring unit 140 may measure pulse energy and identify timing. In other words, the energy of laser pulses may be measured with the PD sensor, and the timing synchronization state with the scanner 120 may be identified. It may be identified whether a laser beam moves accurately to target positions by the scanner 120 and pulse spacing matches exactly. The synchronization monitoring unit 140 may detect whether pulse energy is maintained constantly and whether synchronization between the scanner 120 and laser pulses is precisely achieved based on this information.

Further, the synchronization monitoring unit 140 may adjust synchronization in real-time. The synchronization monitoring unit 140 may collect and analyze real-time data to immediately correct if synchronization errors occur. For example, if the scanner 120 slows down or speeds up, the controller 180 may adjust pulse generation timing to achieve accurate synchronization.

Further, the synchronization monitoring unit 140 may detect and correct errors. If laser pulses do not match scheduled timing or do not match movement of the scanner 120, the synchronization monitoring unit 140 may immediately detect this and take necessary measures. In other words, pulse timing may be readjusted so that processing quality is maintained constantly.

As such, the synchronization monitoring unit 140 may maintain uniform spacing between holes. In other words, uniform spacing between holes may be maintained through precise synchronization of the pulse train and the scanner 120. This is an essential element for high-precision drilling and may ensure consistent quality even in mass production. Further, the synchronization monitoring unit 140 enables high-speed and precise processing. In other words, by precisely matching pulse spacing and the speed of the scanner 120, precise processing may be achieved even at high speed. Thanks to real-time monitoring and adjustment, errors during processing may be minimized and efficiency may be maximized. Further, the synchronization monitoring unit 140 may provide real-time feedback and correct errors. The synchronization monitoring unit 140 may analyze data in real-time to immediately detect and correct errors. Accordingly, problems that may occur during processing may be quickly resolved and consistent quality may be maintained.

Therefore, the synchronization monitoring unit 140 plays an important role in drilling using pulse trains and may maintain uniform spacing between holes by precisely synchronizing pulse spacing and the rotation speed of the scanner 120. By measuring the energy of laser pulses and monitoring synchronization state in real-time, precise results may be obtained even in high-speed processing. Accordingly, processing quality may be maintained constantly and efficiency may be increased.

The vision unit 150 captures a surface of the support in real-time, synthesizes it into a whole image, automatically adjusts a position so that the drilling pattern is aligned with the center of the support, and feeds back processing position and alignment information to the controller 180 to be described below.

To that end, the vision unit 150 may include a charge-coupled device (CCD) vision camera. A CCD vision camera may capture a surface of a workpiece at high speed. A CCD camera may capture high-resolution images in real-time to accurately detect surface conditions during laser processing. The camera may be installed in a chamber where a workpiece is disposed and may accurately capture and analyze the workpiece while it is being processed. The camera may capture a workpiece with the size of the field of view (FOV). As the scanner 120 moves, the capture area changes, and the vision unit 150 may capture a workpiece by dividing it into each FOV size unit. Each FOV is divided into areas of constant size, and as the scanner 120 passes through one area, an image of that area may be captured. After all areas are captured, they may be synthesized to generate a whole image of a workpiece. Further, the vision unit 150 may use vision stitching technology. Here, vision stitching is a technology that synthesizes multiple captured images into a whole shape. Images captured in each FOV are present independently, and through vision stitching, they may be combined into one continuous image to generate a whole profile of a workpiece. This process is performed automatically, and the boundary portions of captured images are well connected so that the shape of the whole workpiece may be accurately reconstructed. Further, after synthesizing the whole image, the vision unit 150 may adjust so that the drilling pattern comes to the exact center of a workpiece. To that end, based on the synthesized whole profile, the position of the drilling pattern is accurately adjusted so that a workpiece may be precisely processed.

The vision unit 150 with such configuration may perform workpiece capture, image synthesis (stitching), center adjustment and drilling pattern optimization, and feedback provision.

In other words, when a workpiece is disposed in a chamber, the CCD vision camera may capture a surface of the workpiece. The scanner 120 moves along a constant path and may capture a workpiece by dividing the capture area into each FOV size unit. The scanner 120 may move at high speed while the camera continuously captures images. Subsequently, images captured in each FOV area are present individually, but through vision stitching technology, they may be synthesized into one whole image. Vision stitching technology is a necessary function to naturally connect boundaries between images and precisely represent a surface of the whole workpiece. The synthesized image is converted to a whole profile, and accurate shape information of a workpiece may be secured. Subsequently, based on the synthesized whole profile, a position may be adjusted so that the drilling pattern comes to the exact center of a workpiece. When a workpiece is disposed at an accurate position, drilling work is performed with respect to the center, and consistent and precise processing is achieved. This helps the drilling pattern be applied uniformly from the center of a workpiece and plays an important role in enhancing processing quality. Finally, the vision unit 150 may capture a surface of a workpiece in real-time, synthesize images, and provide them to the controller 180. The controller 180 may adjust the position of the drilling pattern or placement state of a workpiece based on this information. A workpiece may be automatically position-adjusted as needed.

Such a vision unit 150 may generate an accurate whole profile of a workpiece through image synthesis and position the drilling pattern at the exact center based on this. Accordingly, position errors or imprecise placement problems during processing may be prevented. Further, the vision unit 150 may quickly identify and monitor surface conditions of a workpiece through the CCD vision camera and high-speed capture system. Fine errors or irregularities may be accurately detected using high-resolution images. Further, the vision unit 150 may automatically optimize by aligning the position of the drilling pattern to the center based on the whole profile. Accordingly, the placement of a workpiece and drilling patterns are maintained consistently, contributing to productivity enhancement and quality assurance. Further, the vision unit 150 may ensure high-quality precise drilling thanks to accurate position adjustment and whole profile synthesis through vision stitching. This is particularly advantageous for work requiring precise processing such as porous supports.

As such, the vision unit 150 may play an important role in precisely monitoring a surface of a workpiece through the CCD vision camera and vision stitching technology and automatically adjusting so that the drilling pattern comes to the exact center of a workpiece. Accordingly, processing quality may be optimized and products of consistent quality may be produced. The vision unit 150 may support high-precision processing by providing high-speed and high-resolution real-time monitoring and center adjustment functions.

The processing monitoring unit 160 serves to measure the hole processing depth and hole shape of the porous support in real-time and feed back to the controller 180 to be described below. To that end, the processing monitoring unit 160 may include an optical coherence tomography (OCT) or chromatic confocal system. An OCT system is disposed coaxially with the laser source 110 and may generate images using an interferometer following a laser processing spot. OCT may provide very high-resolution 3D images to detect fine changes or defects that may occur during laser processing in real-time. An interferometer may compare a reflection signal of a laser beam with a reference signal to generate an interference pattern. By analyzing this interference pattern, the depth of a surface or internal structure may be measured and processing conditions may be accurately monitored.

Further, OCT may include spectral domain OCT (SD-OCT) and swept source OCT (SS-OCT). SD-OCT generates images using a spectrum of a laser and may obtain high-resolution images quickly. This method may obtain precise 2D images of processed surfaces through spectrum analysis of laser wavelengths. SS-OCT is a method that generates images using frequency changes of a laser. SS-OCT has excellent faster scan speed and depth resolution, so it may be advantageously used in high-speed processing.

Here, an OCT system may include a steering device. The steering device should accurately move a laser beam to a target surface, and the following devices may be used for this:

Galvano Scanner: Can perform fine adjustments at high speed to scan laser beams at accurate positions.

Resonant Scanner: Provides even higher speed and precision, enabling accurate image acquisition even during high-speed processing.

Polygon Scanner: Can scan quickly using polygonal mirrors and may perform high-speed imaging in large areas.

Meanwhile, the processing monitoring unit 160 may include a central processing unit (CPU), field-programmable gate array (FPGA), or graphics processing unit (GPU) as a data processing device. For example, interference signals may be processed in real-time by high-speed data processing devices such as CPU, FPGA, GPU. These devices may quickly analyze signals to detect processing conditions or surface abnormalities. A CPU handles basic signal processing and calculations, and FPGA and GPU may perform high-speed parallel processing and imaging to quickly analyze and visualize real-time data.

Further, the processing monitoring unit 160 includes a high-speed digitizer, which may serve to convert interference signals collected from an OCT system into digital data. This digital data is subsequently processed by programs to perform imaging. The high-speed digitizer accurately captures rapidly changing signals to enable real-time monitoring.

The processing monitoring unit 160 may perform operations such as laser pulse generation and surface scanning, interference pattern generation, data processing and imaging, processing quality detection and feedback, and high-speed and accurate monitoring.

In laser pulse generation and surface scanning operations, laser pulses generated from the laser source 110 may be accurately delivered to a surface through a steering device (Galvano scanner, resonant scanner, etc.). An OCT system may generate images by capturing reflected signals each time laser pulses touch a processing surface and analyzing those signals. By comparing signals reflected from a surface with reference signals, fine changes or shapes of processed surfaces may be tracked in real-time.

In interference pattern generation operations, an interferometer may compare reflected laser signals with reference signals to generate interference patterns. Through this pattern, the depth information and detailed structures of a surface may be measured. An OCT system may obtain depth information with very high resolution and may detect fine structures or processing conditions of a surface in real-time through this.

In data processing and imaging operations, after the high-speed digitizer converts interference signals into digital data, this data may be processed through CPU, FPGA, GPU. Processed data is converted to image format to visualize profiles or shapes of processed surfaces in real-time. Imaged data monitors processing quality in real-time and may identify whether accurate positions of laser beams or processing conditions are normal.

In processing quality detection and feedback operations, an OCT system may detect problems or irregular phenomena that may occur during processing in real-time. For example, if hole size or spacing does not match during processing or processing depth is not constant, this may be detected immediately. Such real-time data may be transmitted to a control system to take immediate action. For example, if processing depth is too deep or shallow, the laser source 110 output intensity may be adjusted or the scanner 120 speed may be changed to solve problems.

In high-speed and accurate monitoring operations, an OCT system may scan a surface at high speed and monitor processing conditions in real-time through accurate imaging. Particularly, since precise quality control is important in high-speed laser processing, OCT may play a very useful role.

Such a processing monitoring unit 160 may detect fine changes occurring during processing in real-time through high-resolution imaging by an OCT system. Further, OCT may accurately track the depth information of a surface to identify in real-time whether processing is being performed accurately. This method is very useful particularly when processing complex shapes or performing fine processing. By utilizing the high-speed digitizer and parallel processing systems (CPU, FPGA, GPU), data may be processed in real-time and images may be generated to quickly detect errors during processing. Accordingly, defective processing may be prevented in advance and productivity may be enhanced. An OCT system is suitable for high-speed laser processing and may detect problems occurring during processing in real-time to quickly correct them, enabling high productivity and efficient processing.

As such, the processing monitoring unit 160 including an OCT system may play an important role in detecting fine changes that may occur in high-speed laser processing in real-time, precisely monitoring them, and optimizing processing quality. Through the high resolution of OCT and real-time image processing, problems during processing may be quickly discovered and automatically corrected to provide high-quality results.

The suction jig unit 170 may quickly remove heat accumulation and scattered particles that may occur in laser drilling to enhance processing quality and prevent unexpected deformation. To that end, the suction jig unit 170 may include at least one of a suction jig, a side exhaust device, and a cooling unit.

The suction jig is a pressurized jig that fixes the porous support to prevent workpiece deformation and enhance worker safety, serving to fix the position of a material. Further, the suction jig may provide a function to effectively remove heat and scattered particles generated during laser processing. During laser drilling, the suction jig fixes a material to prevent unnecessary movement and helps processing be performed at accurate positions. Accordingly, processing accuracy may be enhanced.

The side exhaust device may work together with the suction jig to immediately remove scattered particles or contaminants generated during processing. To that end, the side exhaust device may include a blower and an exhaust unit. Here, the blower is an air compression device that may quickly remove contaminants or particles around a processing area and may clean material surfaces and prevent heat accumulation. Further, the exhaust unit may work in conjunction with the suction jig to serve to safely discharge sucked smoke or fine particles to the outside. Accordingly, the work environment may be kept clean and workers' health may be protected.

The cooling unit is integrated into the suction jig to enhance laser cold ablation efficiency. Such a cooling unit may maintain constant temperature of a material during processing and contribute to maintaining processing quality by preventing excessive heat accumulation.

The suction jig unit 170 may perform operations such as material position fixing and heat removal, contamination removal and scattered particle suction, processing condition stability maintenance, and processing quality optimization.

In other words, the suction jig may accurately fix a material during laser drilling. Accordingly, a material is prevented from moving or deforming, and a laser beam may process at accurate positions. Further, heat generated during laser processing may be removed through the cooling unit. The suction jig may prevent heat from accumulating and increase cold ablation efficiency to suppress non-uniform hole shapes or excessive taper that may occur during processing.

If scattered particles or contaminants accumulate on a surface during laser drilling, they may adversely affect processing quality. The suction jig and side exhaust device immediately remove these to help processing be performed accurately. The blower and exhaust unit may clean processing surfaces and quickly suck and discharge scattered particles or smoke to the outside. Accordingly, the work environment is kept clean and processing quality may be enhanced.

The suction jig and side exhaust device may maintain processing quality constantly by continuously controlling the temperature and contamination state of a material during processing. By preventing heat accumulation or contaminants from remaining on a surface, problems such as non-uniform hole shapes or material removal may be prevented.

Preventing cracks or non-uniform hole shapes in recast layers after melting during laser drilling is very important. The suction jig unit 170 may optimize processing quality through real-time management of material surface temperature and scattered particles and accurate position fixing.

Such a suction jig unit 170 enhances processing quality by simultaneously handling material fixing and contamination removal. Through heat removal and scattered particle suction, non-uniform hole shapes or excessive taper may be prevented and accurate processing may be realized. Further, the suction jig unit 170 may keep the work environment clean by quickly removing scattered particles or contaminants. Accordingly, workers' health may be protected and factors affecting processing quality may be minimized. Further, through the automated cooling unit that increases cold ablation efficiency to prevent heat accumulation and quickly removes scattered particles, problems that may occur during processing may be prevented. Further, through material position fixing and heat removal, material deformation or removal may be prevented and constant hole shapes may be maintained. Accordingly, high-precision processing may be ensured.

As such, the suction jig unit 170 may play an important role in effectively removing heat accumulation and scattered particles that may occur in a laser drilling system to enhance processing quality and keep the work environment clean. Through the suction jig and side exhaust device and cold ablation efficiency, non-uniform hole shapes or excessive taper that may occur during processing may be suppressed and high-precision processing may be ensured. This suction jig unit 170 may support efficient and safe processing by simultaneously handling multiple functions such as material fixing, contamination removal, and heat management.

The controller 180 plays a very important role in the laser processing system 100 and may control the various components described above in a centralized manner. To that end, the controller 180 may include an industrial PC (IPC). An IPC is the core processing device of the controller 180 and may serve as the central processing system of the system. An IPC may manage and control all operations of the laser processing system 100 by integrating hardware and software.

An IPC may process data in real-time through high-speed processing and adjust operations of each component. Accordingly, the efficiency and reliability of the system may be ensured.

As described above, the controller 180 controls the laser source 110 and the scanner 120 such that the pulse repetition frequency of the laser source 110 and the moving speed of the scanner 120 are synchronized to form holes with constant spacing, constant width, and constant depth in the porous support.

In this case, the controller 180 may control in the following two ways.

It may control the pulse repetition frequency of the laser source 110 and the moving speed of the scanner 120 to be synchronized through ratio-based control.

It may control the laser source 110 and the scanner 120 such that the pulse repetition frequency of the laser source 110 and the moving speed of the scanner 120 are synchronized based on a synchronization monitoring signal received from the synchronization monitoring unit 140.

The controller 180 controls “on/off” states of the laser source 110 and may adjust settings such as pulse energy and pulse spacing to accurately provide laser light necessary for processing work.

For example, based on bitmap data converted from CAD files, the laser source 110 may be turned “on” or “off” at specific positions, and through this, laser processing may be accurately performed in necessary areas.

Further, the controller 180 may control the beam splitter 130 to distribute laser beams to multiple beams. Accordingly, beams generated from one laser source 110 may be accurately delivered to multiple positions, and multiple processing may be performed simultaneously.

The controller 180 may manage the intensity and direction of laser beams distributed from the beam splitter 130 and adjust to provide appropriate amounts of laser beams to each processing area.

Further, the controller 180 may control the processing monitoring unit 160. The processing monitoring unit 160 may monitor temperature, pressure, processing depth, etc. generated during processing in real-time. The controller 180 may collect this data and identify whether processing is being performed normally based on this.

If errors or abnormal conditions are detected during processing, the controller 180 may immediately issue adjustment commands or activate warning systems to solve problems.

Further, the controller 180 may control the vision unit 150. The controller 180 may monitor processing conditions in real-time through CCD cameras or image processing systems in conjunction with the vision unit 150. Based on images provided by the vision unit 150, processing quality may be analyzed and operations of the laser source 110 or the scanner 120 may be adjusted as needed.

For example, positions or sizes of holes may be identified through images provided by the vision unit 150, and processing may be optimized based on this.

Further, the controller 180 may control the synchronization monitoring unit 140. The controller 180 may adjust synchronization states of laser pulses and the scanner 120 in real-time through the synchronization monitoring unit 140. By precisely matching the movement speed of the scanner 120 and spacing of laser pulses, constant hole spacing and uniform processing depth may be maintained. The controller 180 may automatically adjust pulse spacing based on data provided by the synchronization monitoring unit 140 to minimize delays or errors that may occur during processing.

Further, the controller 180 may control the scanner 120. The controller 180 controls the position and movement path of the scanner 120 to move laser beams to accurate positions. The scanner 120 may move at high speed while accurately placing laser beams at target positions. The controller 180 may calculate paths of the scanner 120 based on bitmap data converted from CAD files and control in real-time to accurately scan laser beams to desired positions.

Further, the controller 180 may control the suction jig unit 170. The controller 180 may adjust fan speed or suction nozzle positions of the suction jig unit 170 in real-time to immediately suck and remove smoke or fine particles generated during processing. Further, the controller 180 may monitor operations of the suction jig unit 170 and adjust fan speed as needed to optimize work environments.

Meanwhile, the controller 180 may receive CAD files, convert them to bitmaps, and set “on/off” of the laser source 110 and paths of the scanner 120 based on this. According to bitmaps, the laser source 110 may be controlled in specific ranges and movement of the scanner 120 may be adjusted to perform accurate processing.

Further, the controller 180 may collect real-time data from each device to control operations of the laser source 110, the scanner 120, the suction jig unit 170, the vision unit 150, etc. in real-time. For example, processing quality may be monitored in real-time, and immediate action may be taken if errors are detected. Further, based on data provided by the synchronization monitoring unit 140, the speed of the scanner 120 and pulse spacing may be automatically adjusted to optimize processing quality.

Further, the controller 180 may detect errors or abnormal processing conditions occurring during processing in real-time and immediately correct them. For example, based on images provided by the vision unit 150 or OCT systems, processing quality may be analyzed and the intensity of the laser source 110 or the speed of the scanner 120 may be automatically adjusted as needed.

Further, the controller 180 may adjust operations of each component in real-time through feedback systems. Based on image data provided by the vision unit 150 or information collected by the synchronization monitoring unit 140, positions of the laser source 110 or the scanner 120 may be automatically optimized.

The controller 180 controls and adjusts the laser source 110, the scanner 120, the suction jig unit 170, the vision unit 150, the synchronization monitoring unit 140, etc. in real-time to perform accurate processing. Accordingly, uniform spacing between holes, uniform width, and uniform processing depth may be maintained. The controller 180 may maintain quality while increasing productivity even in high-speed processing environments through high-speed data processing and automated control functions. The controller 180 may quickly solve errors that may occur during processing through real-time error detection and automatic correction functions, preventing defective processing and enabling efficient production. The controller 180 may integrally manage all components of the system and provide feedback between devices to maintain processing quality and optimize work environments.

As such, the controller 180 serves as the central processing system in the laser processing system 100 and may control and adjust at least one or all components among the laser source 110, the scanner 120, the beam splitter 130, the synchronization monitoring unit 140, the vision unit 150, the processing monitoring unit 160, and the suction jig unit 170 in real-time. Accurate processing paths may be set based on bitmap data converted from CAD files, and high-quality results may be provided even in high-speed processing environments through automated optimization and feedback systems. Processing quality may be maintained and work environments may be safely optimized through real-time error detection and correction functions.

The controller 180 monitors synchronization states between the pulse repetition frequency (PRF) of the laser source 110 and movement speed of the scanner 120 in real-time and adjusts to maintain constant processing spacing (spacing between holes) based on the synchronization relationship.

Further, the controller 180 may perform combination control of scanner speed and pulse repetition frequency (PRF) at reference ratios to prevent processing density or heat overlap, considering the effects that the spacing between holes and laser energy distribution have on processing quality, not just maintaining simple synchronization.

For example, when movement speed of the scanner decreases or PRF becomes excessively high, the amounts of heat accumulation overlapping at the same position may increase, which may cause problems such as hole overheating, shape distortion, and material damage. To prevent such problems, the controller readjusts scanner speed and pulse repetition frequency based on preset allowable density or maximum thermal exposure factor (TEF) as standards, and in this process, may perform processing optimization for holes based on the following relational expressions.

Accordingly, the controller 180 may integrally calculate the spacing between holes, processing diameter, accumulated number of pulses, etc. according to given design standards and automatically adjust so that processing heat does not accumulate excessively, thereby stably maintaining processing quality even in high-speed continuous processing environments. Below, hole processing diameter, the spacing between holes, accumulated number of pulses, spacing between lines, etc. is examined.

### Hole Diameter (Dₕ)

In high-speed scanner-based laser drilling, one laser pulse or accumulated pulse trains locally remove metal supports to form holes. In this case, the diameter (size, width) of holes may be determined by the spot diameter of a laser beam in the above-described [Equation 1] and heat diffusion range according to thermal interaction between laser and material.

When laser pulses are incident on metal surfaces, some energy is conducted in heat form to affect adjacent areas. The longer pulse width is, the larger the range of heat diffusion becomes, and actual hole size may become larger due to this. When heat diffusion length is called lₜₕ, the diameter Dₕ of holes may be obtained by approximation as in the following [Equation 2].

$${D}_{h} = {d}_{f} + 2 {l}_{th} = \frac{4 \cdot f \cdot λ \cdot {M}^{2}}{{d}_{0} \cdot π} + 2 \sqrt{4 \cdot α \cdot τ} \qquad [ Equation 2 ]$$

Here, Dₕ is hole diameter, d_{f} is the spot diameter of a laser beam, lₜₕ is heat diffusion length, d₀ is the diameter of an incident beam (diameter of an incident laser beam), λ is the wavelength of a laser beam, f is the focal length of a laser beam, M² is beam quality (a numerical value representing the quality of a laser beam, with ideal beam quality being M²=1), d₀ is the diameter of an incident laser beam, a is thermal diffusivity of material, and τ is pulse duration (sec).

Meanwhile, the spot diameter of a laser beam in the [Equation 2] is according to Gaussian beam theory, but may also be calculated according to optical diffraction limit conditions as follows. If the theoretical minimum spot radius ω₀ of a laser beam according to optical diffraction limit is ω₀,

$${w}_{0} = \frac{1.22 \cdot f \cdot λ}{D}$$

and, in this case, the hole diameter Dₕ may also be obtained by approximation as in the following [Equation 3]. Appropriate mathematical expressions may be used according to whether diffraction conditions of design optical systems or beam quality index (M²) are reflected.

$${D}_{h} = 2 {w}_{0} + 2 {l}_{th} = 2 \frac{1.22 \cdot f \cdot λ}{D} + 2 \sqrt{4 \cdot α \cdot τ} \qquad [ Equation 3 ]$$

Here, Dₕ is hole diameter, ω₀ is the theoretical minimum spot radius of a laser beam under optical diffraction limit conditions, lₜₕ is heat diffusion length, λ is the wavelength of a laser beam, f is the focal length of a laser beam, D is the physical diameter of an incident beam as aperture diameter, a is thermal diffusivity of material, and t is pulse duration (sec).

### Inter-Hole Distance

Lasers are fired at constant pulse periods, and as the scanner 120 moves at constant speed, each pulse is allocated to each hole position. The distance the scanner moves during time intervals between pulses becomes the position of the next hole. Therefore, the spacing between holes may be obtained from the following [Equation 4].

$${d}_{h} = \frac{{v}_{scan}}{{f}_{p}} \qquad [ Equation 4 ]$$

Here, dₕ is spacing (distance) between holes, Vscan is the linear velocity of the scanner 120, and fₚ is pulse repetition frequency.

Therefore, if the scanner 120 speed increases, the distance between holes becomes farther, and if pulse repetition frequency increases, the distance between holes becomes closer. For example, if the scanner 120 speed Vs is 200 mm/s and pulse repetition frequency fₚ is 20 kHz, then the spacing dₕ between holes becomes 200/20000=0.01 mm=10 μm.

If the spacing between holes is smaller than hole diameter, holes overlap causing excessive heating and non-uniform hole shapes; if the spacing between holes equals hole diameter, hole boundaries touch creating lines instead of holes; if the spacing between holes is sufficiently larger than hole diameter, spaces are present between holes preserving structural strength and enabling porous forms. Therefore, it is important to maintain the spacing between holes above a predetermined size during design.

### Number of Pulses Assigned to One Hole

When total line length is L, the number of holes Nₕₒₗₑ formed on line L may be calculated as L/dₕ. Therefore, the total number of pulses allocated to one hole, i.e., the total number of pulses accumulated in each hole may be obtained as in the following [Equation 5].

$${N}_{\frac{pulse}{hole}} = \frac{( {N}_{pass} \cdot {f}_{p} \cdot {T}_{scan} )}{{N}_{hole}} = \frac{{N}_{pass} \cdot {f}_{p} \cdot {T}_{scan} \cdot {d}_{h}}{L} = \frac{{N}_{pass} \cdot {f}_{p} \cdot {d}_{h}}{{v}_{scan}} \qquad [ Equation 5 ]$$

Here,

$${N}_{\frac{pulse}{hole}}$$

is the total number of pulses accumulated in one hole (total number of pulses allocated to each hole), Nₚₐₛₛ is the number of times scanning is repeated for the same line, fₚ is the pulse repetition frequency of a laser, T_{scan} is the time required per single scan, dₕ is the spacing between holes, Lis the length of the entire scan line, and Vscan is the linear velocity of the scanner.

By increasing the number of scan repetitions for lines, more pulses may be accumulated in each hole, enabling processing of deeper holes or cleaner holes with gentle taper. Further, since scanner speed is L/T_{scan}, the faster scanner speed is, the larger pulse distribution spacing becomes compared to the same time, so accumulated pulses decrease. Further, the higher pulse repetition frequency is, the more pulses may be distributed within the same distance.

### Line Spacing According to Hole Arrangement

When disposing holes in line units on metal supports, hole density per unit area, heat effect distribution, and shape quality vary according to hole arrangement patterns. Particularly, rectangular arrangement patterns and triangular arrangement patterns (triangular, hexagonal, or dense type) are representative pattern types, and line spacing differs according to pattern types.

In rectangular arrangement patterns, each hole is aligned in horizontal and vertical directions, and each hole is preferably disposed in square or rectangular grids. When disposed in square grids, the spacing between holes is the same as the spacing between lines.

In triangular arrangement patterns, holes in even-numbered lines are offset horizontally by half of the spacing between holes, and the spacing between upper and lower lines is also adjusted. This method is very effective for increasing hole density per unit area. The following [Equation 6] is a formula for obtaining the distance between lines in equidistant triangular grids (based on equilateral triangles).

$${d}_{l} = \frac{\sqrt{3}}{2} \cdot {h}_{h} \qquad [ Equation 6 ]$$

Here, dₗ is the spacing between lines and dₕ is the spacing between holes.

The hole density of rectangular arrangement patterns is

$$\frac{1}{{d}_{h}^{2}} ,$$

and the hole density of triangular arrangement patterns is

$$\frac{2}{\sqrt{3} \cdot {d}_{h}^{2}} ,$$

so triangular arrangement patterns have about 15.5% or more higher density per unit area than rectangular arrangement patterns.

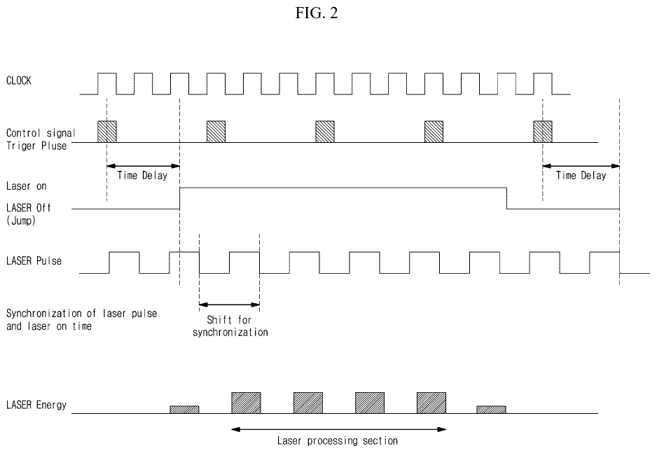

FIG. 2 is a waveform diagram for time synchronization of the porous support laser processing system 100 according to the present invention. According to FIG. 2, clock signal, control signal (trigger pulse), laser on and laser off, laser pulse, synchronization of laser pulse and laser on time, and laser energy are illustrated in order from top to bottom.

The porous support laser processing system 100 according to the present invention may include at least one function among high-speed drilling, signal monitoring, and processing monitoring. High-speed drilling is the main function of the laser drilling system, which is a process of quickly drilling high-precision holes in materials. The laser source 110 may emit a series of pulse trains (pulses occurring continuously with temporal spacing) with uniform energy. This pulse train may play an important role in implementing high-speed drilling. Through beam steering devices, laser beams are accurately delivered to processing targets, and these laser beams may be transmitted with spatial spacing by the scanner 120 moving at high speed.

Laser energy focused at high density is concentrated on materials, enabling high-speed perforation. The perforation size may be determined by laser energy size, pulse duration, pulse spacing, etc. As drilling progresses, laser beams proceed with perforation at accurate spacing, and this process occurs in conjunction with movement of the high-speed scanner 120.

Signal monitoring is also the main function of laser systems, which may serve to synchronize laser beam pulse signals and position movement of the scanner 120 in real-time.

Here, as illustrated in FIG. 2, laser beam on/off signals and pulse signals are often transmitted asynchronously with position movement commands of the scanner 120. Accordingly, when starting processing, the position and energy intensity of first spots become inconsistent, making it difficult to ensure repeatability.

Further, in acceleration and deceleration sections of the scanner 120 occurring at start and end points of processing lines, it may become difficult to maintain constant spacing between spots. If synchronization is not properly achieved, focused energy becomes insufficient and processability may deteriorate.

Accordingly, the system according to the present invention may monitor synchronization between laser signals and optical output signals in real-time using high-speed signal processing systems such as field-programmable gate arrays (FPGA). FPGA solves synchronization problems in real-time through high-speed data processing and enables accurate position control.

By sharing the same clock signal among the laser source 110, the scanner 120, and the controller 180, time-based synchronization is achieved so that operations of each component may match accurately. Processing monitoring is a function that monitors the quality and accuracy of perforation in real-time in laser drilling systems and optimizes by adjusting processing parameters. The shapes and arrangements of individual through holes may importantly affect product performance. However, measuring thousands to hundreds of thousands of fine patterns on front and back sides retrospectively is very inefficient.

The shapes and position deviations of perforated holes may be identified using 2D/3D line cameras, but there are limitations due to phenomena such as illumination problems or warpage. To solve this, more precise processing monitoring systems are needed.

The system according to the present invention may mount inline coherence imaging (ICI) modules such as optical coherence tomography (OCT) to monitor hole shapes, taper, surface non-uniformity, etc. in real-time during laser processing. OCT systems may measure the depth and shapes of surfaces at high resolution in non-contact manner, enabling accurate understanding of processing conditions and real-time adjustment. The shapes and position deviations of perforation holes after processing may be measured in real-time through OCT, and processing parameters may be automatically adjusted based on these results to maintain optimal processing quality.

As high-speed drilling is performed, synchronization of the laser source 110 and the scanner 120 should be precisely achieved for perforation quality to be maintained constantly. To that end, FPGA-based high-speed signal processing systems may be used. Problems occurring during processing may be understood in real-time through OCT systems, and parameter adjustments are made to solve these. This enables laser processing to be optimized to be both high-speed and precise. The system according to the present invention may maintain processing quality through automated control, correct problems such as energy shortage or desynchronization in real-time, and ensure consistent quality laser processing.

As such, the system according to the present invention may provide the main functions necessary for implementing high-speed yet precise laser processing through high-speed drilling, signal monitoring, and processing monitoring. Synchronization problems may be solved using high-speed signal processing systems such as FPGA, and optimal processing quality may be maintained by providing real-time processing monitoring through OCT systems. This system ensures accurate perforation, high productivity, and consistent quality, and may be very usefully utilized in various high-speed laser processing application fields.

Below, various working methods by the laser processing system 100 according to the present invention is described. Working methods may include 1) multi-path processing, 2) processing direction, 3) processing sequence, 4) processing division, 5) line spacing, 6) distance adjustment, etc., which are described in detail.

### Multi-Path Processing

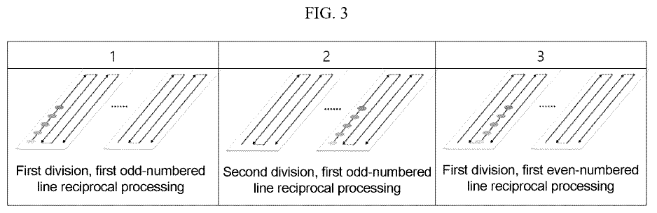

FIG. 3 is a view illustrating an example of a working method by the porous support laser processing system 100 according to the present invention. As illustrated in FIG. 3, multi-path processing such as (1) first division, first odd-numbered line reciprocal processing, (2) second division, first odd-numbered line reciprocal processing, (3) first division, first even-numbered line reciprocal processing is possible.

Multi-path processing is a method for implementing high-speed yet precise perforation in laser drilling. In this process, percussion drilling is utilized to repeatedly use high-frequency laser pulses, and excessive taper formation or material deformation may be minimized. However, several problems may occur in this method, and system operations to solve these is described below in detail.

Percussion drilling is a method that performs processing gradually by repeatedly using high-frequency laser pulses. This method enables high-speed drilling and helps prevent excessive taper or material deformation during processing. However, this method may cause several problems when using multi-pulses at fixed positions.

When performing drilling with multi-pulses, phenomena where heat accumulates without being able to escape with each pulse may occur. When laser pulses are repeatedly used at fixed positions, each pulse does not give enough time to sufficiently emit heat and new pulses occur again, causing heat accumulation. Accordingly, the temperature at processing points may exceed melting points, which may cause unstable deformation or deteriorate processing quality.

At processing points exceeding melting points, energy shielding phenomena by scattered particles and plasma may occur. Shielding phenomena may reduce the energy delivery of subsequent pulses by laser pulses being blocked by plasma or scattered particles. This problem becomes more serious particularly when successive pulses are repeated at 500 kHz or higher.

To solve such heat accumulation and energy shielding problems, high-speed scan technology may be used. High-speed scanning is effective in suppressing heat accumulation and energy shielding phenomena by quickly dispersing pulses to areas.

The scanner 120 moving at high speed may quickly disperse laser pulses throughout work areas so that pulse energy is not concentrated at one point. Accordingly, heat accumulation may be prevented and temperatures at processing points may be prevented from rising excessively.

Laser pulses overlap according to the number of scans, and etching may proceed gradually. This gradual etching method may help minimize material deformation while maintaining processing quality while proceeding at high speed.

Pulse energy is dispersed throughout work areas, and through this, processing speed may be increased and material deformation may be prevented. Using high-speed scanning, laser beams move quickly through work areas, and each pulse overlaps to proceed with etching gradually. Accordingly, material deformation or excessive taper may be prevented even when using high pulse output.

To optimize processing speed and quality, the number of lines may be determined by line spacing distance. This spacing distance is related to the maximum speed (line rate) of the scanner 120. The period f_{eff} where one hole is repeated may be determined by the following [Equation 7].

$${f}_{eff} = \frac{{f}_{line}}{( \frac{W}{h} + 1 )} \qquad [ Equation 7 ]$$

f_{eff}: period where holes are repeated
fₗᵢₙₑ: maximum speed (line rate) of the scanner 120
W: processing area width
h: spacing distance

Through the formula, processing periods are determined according to the maximum speed of the scanner 120, and efficient processing may be realized by adjusting spacing distances between lines.

Multi-path processing prevents heat accumulation and energy shielding that may occur during laser processing through high-speed scanning and pulse dispersion, and enables high-speed processing while minimizing material deformation. Pulse energy is dispersed throughout work areas to increase processing speed through gradual etching and maintain processing quality. Further, by optimizing line spacing distances and the spacing between pulses, precise laser processing becomes possible. Accordingly, precise perforation may be realized while using high pulse output and high-speed scanning.

### 2) Processing Direction

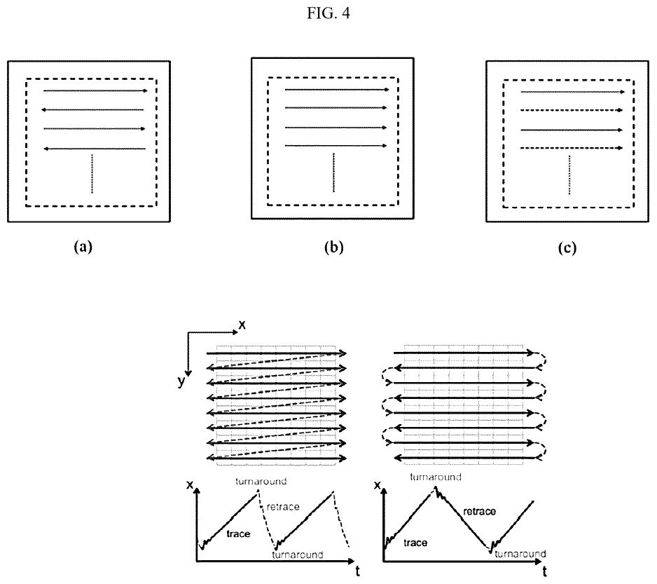

FIG. 4 is a view illustrating an example of a working method by the porous support laser processing system 100 according to the present invention.

The processing direction may play an important role in optimizing work speed and precision in laser drilling. Since processing speed and quality vary according to various scan methods and scan directions, it is important to understand these well and select them appropriately.

Bidirectional scanning is a method frequently used to enhance overall work speed in laser processing. In bi-directional scanning, laser beams may move in two directions to cover processing areas. On the other hand, unidirectional scanning may perform processing while laser beams move in only one direction.

Unidirectional scanning has the advantage of long straight sections, enabling decreased scan time and high-speed processing. It is mainly advantageous for increasing processing efficiency in sawtooth scanning format.

However, since retracing in unidirectional scanning is performed asymmetrically, duty cycles are small, and actuators may overheat due to this.

Additional shutters may be needed to prevent photobleaching caused by this. A shutter may serve to control excessive exposure of laser beams and prevent material damage in high-temperature conditions.

Bidirectional scanning may maximize straight processing areas to increase overall work speed and implement efficient processing. However, securing scan accuracy may be difficult during high-speed processing. In other words, mismatches between trace and retrace may occur due to phase lag and nonlinearity problems. Accordingly, precision may deteriorate and processing quality may be affected.

Scan methods may include zigzag scanning, unidirectional raster scanning, and alternating line scanning. Zigzag scanning may perform processing while laser beams move in zigzag shapes. This method enables efficient area coverage and high-speed processing, but there may be challenges regarding accuracy or geometric structures. Unidirectional raster scanning proceeds with processing in one direction, and since processing is performed in straight paths, processing time does not become long and constant accuracy may be maintained. In unidirectional scanning, retracing is necessary, and overheating that may occur during processing may be prevented through shutters. Alternating line scanning may proceed with processing while laser beams move alternately with spacing distances between lines in processing areas. This method may maintain efficient processing and uniform patterns and enable various types of processing.

Meanwhile, one of the problems occurring in high-speed scanning is the mismatch between trace and retrace due to phase lag and nonlinearity. This may deteriorate processing accuracy and quality and may appear more prominently particularly in bi-directional scanning.

To solve this, it is important to balance scan speed and accuracy. Methods to increase scan accuracy include adjusting scan paths or using control systems to correct phase lag to increase matching between trace and retrace.

The processing direction and scan methods may play important roles in balancing precision and speed in high-speed processing. Unidirectional scanning is high-speed but precision problems may occur due to retracing, and bi-directional scanning maximizes straight areas but may have difficulties in scan accuracy. To solve this, control technologies and complementary devices such as shutter devices that may solve phase lag and nonlinearity problems are needed. Appropriate selection of each method and scan mode is important for optimizing processing speed and precision.

### 3) Processing Sequence

The processing sequence is an important factor that greatly affects work speed and precision in the laser processing system 100. Sequential scanning and interlacing scanning methods differ according to processing methods of scan lines, and each method may differently affect processing efficiency and precision. Below, the characteristics of each method and the effects of processing sequence accordingly may be described in detail.

Sequential scanning is a method that performs processing while laser beams move line by line following raster pattern order. This method is a method that processes processing areas step by step, and processing is performed along linear paths.

In sequential scanning, laser beams may scan processing areas line by line from left to right or from top to bottom. Since one line at a time is processed, processing progress is linear and predictable.

Sequential scanning may cover many sections at once because processing proceeds step by step. However, more time may be required compared to other methods.

Since this method has constant processing paths and proceeds along straight paths, processing quality may be maintained uniformly. However, since processing is performed only in one direction, additional time may be required in retrace sections.

Interlacing scanning is a method of scanning with lines spaced by interlace distance (ΔIL) which is a multiple of hatch distance (ΔH). In this method, processing may be performed while regularly skipping some scan lines.

In the interlacing method, laser beams may skip scan lines partially after a first pass and start again. Later, when starting a next pass, scanning may start with the same offset (ΔH) as a previous pass. As such, missing lines are filled in order.

Since the interlacing method processes each line sequentially instead of skipping some lines while proceeding with processing, it may provide efficient processing speed. This method may increase processing speed and help complete processing quickly while avoiding redundant work.

This method may be faster in processing speed compared to sequential scanning and may efficiently skip multiple lines while performing processing. Continuous processing is possible, reducing work time and enabling efficient pattern generation. However, this method may cause mismatches. In other words, trace and retrace may not match, and processing precision may deteriorate. Fine errors may occur between previous laser beams and next passes due to phase lag or nonlinearity.

Interlacing continues repeatedly until all missing lines are filled, and each pass may maintain the same offset (ΔH) as previous passes. This repetitive process may contribute to increasing processing accuracy.

Interlacing scanning provides efficient work processing, i.e., speed may increase because more lines are skipped and processed at once. Further, interlacing scanning maintains processing quality, i.e., precise perforation may be maintained by repeatedly filling missing lines.

However, interlacing scanning has mismatch problems, i.e., accuracy may deteriorate due to mismatches between trace and retrace. Further, since this method requires very accurate synchronization of the controller 180, advanced control systems supporting this are needed.

The processing sequence greatly affects processing speed and precision, and methods to optimize this include sequential scanning and interlacing scanning. Sequential scanning is advantageous for increasing precision but may place limitations on speed, and interlacing scanning increases efficiency and increases work speed but may require additional management for precision. It is important to appropriately select these two methods to set optimal processing sequences suitable for work environments and requirements.

### 4) Processing Division

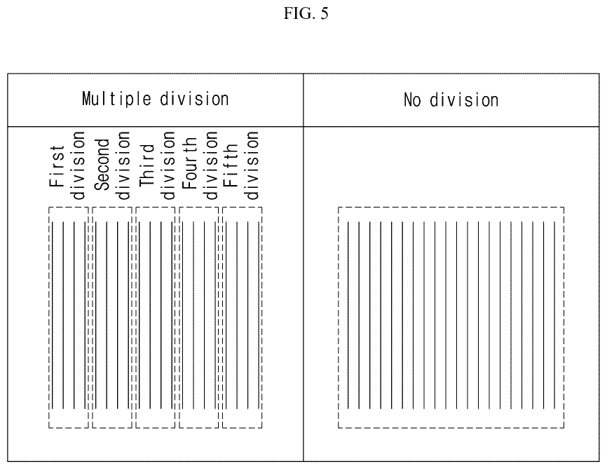

FIG. 5 is a view illustrating an example of a working method by the porous support laser processing system 100 according to the present invention.

Processing division is an important method for efficiently processing work areas in the laser drilling and processing system 100. This method helps optimize work speed and precision and is useful for solving specific problems. Below, processing division methods may be described in detail.

When proceeding with processing, a method of processing by spacing line order is generally advantageous. When processing by spacing lines, each line is evenly distributed to increase processing efficiency and may have effects of shortening work time.

When processing by spacing lines at constant intervals, laser beams may be evenly distributed to materials and processing quality may also be maintained constantly. However, if the spacing distance becomes excessively far, the time required for movement of the scanner 120 becomes large, and overall processing time may increase. In other words, inefficient scanning occurs, and work speed may become slow due to this.

To solve this, a method of processing by dividing processing areas into uniform area units may be used. This method enables efficient scanning by equally dividing work areas and processing each section independently.

When work areas are divided into constant area units, movement distances of the scanner 120 are maintained constantly in each unit area, and unnecessary movement time may be decreased. When processing proceeds in evenly divided areas like this, the movement speed and time efficiency of the scanner 120 may be optimized.

This may shorten processing time and accurately process each section. Further, the time and distance required for movement of the scanner 120 are decreased, enabling efficient work.

Further, processing consistency may be maintained in each evenly divided area, increasing precision and preventing unbalanced processing.

Meanwhile, processing division may play an important role in balancing speed and precision. When processing in equally divided area units, each section may be processed efficiently to increase overall processing speed, and work quality may also be maintained constantly.

Since movement distances of the scanner 120 are maintained constantly in evenly divided areas, the time required for movement of the scanner 120 is decreased, and overall work may be completed quickly and accurately.

Further, by processing independently in each area unit, unbalanced processing does not occur and accurate perforation is achieved.

Processing division is an important method that solves problems that may occur in line spacing methods and enables efficient and precise processing by evenly dividing work areas. When processing by equally dividing into area units, movement distances of the scanner 120 are optimized, overall work time is shortened, and accuracy and processing quality may be maintained constantly. This method is very useful in high-speed processing environments and may realize efficient laser drilling.

### 5) Line Spacing

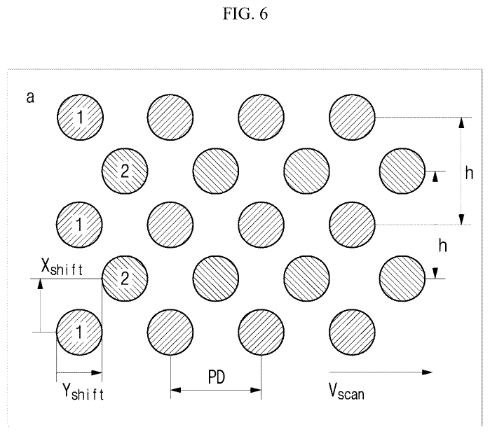

FIG. 6 is a view illustrating an example of a working method by the porous support laser processing system 100 according to the present invention.

Line spacing is an important factor for adjusting the density and accuracy of hole patterns in laser processing. When pulse distribution and line spacing are appropriately set, processing speed and precision may be optimized simultaneously. Below, the effects that line spacing has on pattern density and efficient processing methods that may be obtained through this may be described.

During processing, laser beams may perforate material surfaces with constant pulse spacing (PD, dₕ). In this case, line spacing affects pulse distribution and is an important factor determining the density of hole patterns.

By adjusting X and Y direction offsets, the spacing between adjacent lines may be changed. In this case, by adjusting spacing distances of lines in X and Y directions, rectangular arrangements may be changed to diamond or hexagonal patterns. This method is effective for increasing pattern density.

For example, when the spacing between holes is dₕ (PD), if spacing is decreased by 10-20% in X direction and decreased by half in Y direction, density may increase by about 15% compared to rectangular arrangements. By increasing density like this, more perforations may be made in the same area, enabling efficient processing.

By utilizing delay time, line spacing may be additionally optimized. This method may help increase pattern density without extending processing paths.

In other words, by appropriately setting delay time, the spacing between pulses may be finely adjusted. Accordingly, line spacing may be optimized and pattern density may be increased. Processing efficiency may be enhanced without changing processing speed.

When scan speed becomes very fast, laser beams tend to become longer along traveling directions during pulse duration. This may cause problems where the density of laser beams may be formed non-uniformly as movement speed of the scanner 120 becomes faster.

When there is acceleration and deceleration, scan speed changes rapidly and the density of laser beams may be formed irregularly. Accordingly, processing may become unbalanced or precision may deteriorate.

To solve this, it is important to accurately set scanner speed and pulse repetition frequency. These two factors are main factors determining the spacing between holes dₕ.

The spacing between holes PD (dₕ) may be obtained from the above-described [Equation 4]. Through this formula, by adjusting scan speed and pulse repetition frequency, the spacing between holes (pulse spacing) may be set so that laser beams may perforate at accurate positions.

When scan speed becomes faster, the spacing between holes becomes shorter enabling more perforations, but in this case, adjustments should be made so that laser beam density does not become irregular.

By adjusting pulse repetition frequency, each pulse may be controlled not to continue too quickly.

Line spacing is an important factor for adjusting hole pattern density and increasing processing efficiency. By appropriately setting X and Y direction offsets, pattern density may be increased by 15%, and processing paths may be efficiently optimized by utilizing delay time. Further, by adjusting scan speed and pulse repetition rate to optimize the spacing between pulses, accurate perforation and processing quality may be maintained while increasing processing speed. As such, precise laser processing may be realized through line spacing.

### 6) Distance Adjustment

Distance adjustment plays a very important role in laser processing and is an essential factor for optimizing processing quality and precision. Particularly, distance adjustment between the scanner 120 and materials may be performed to solve problems that may occur in lasers using Gaussian beams. Below, the necessity of distance adjustment and its effects may be described.

A Gaussian beam is the most commonly used beam form in lasers. This beam has characteristics where energy is concentrated in central portions and energy is dispersed as it goes to the outside. Accordingly, if focus is not aligned, the size of beams forming on surfaces extends, processing performance deteriorates, and taper may be formed excessively.

If the focus of a Gaussian beam is not accurately aligned, beam size extends and processing depth and accuracy may decrease.

Taper (inclination of processed holes) intensifies, and processed holes may be formed non-uniformly due to this. This may seriously affect processing quality.

Distance adjustment is a method of periodically adjusting distances between the scanner 120 and materials in multi-pass machining, which may solve problems where focus is not accurately aligned. By adjusting distances between the scanner 120 and materials during processing, beam size increase may be prevented and constant processing depth and accuracy may be maintained.

In multi-path processing, as laser beams repeatedly perform processing multiple times, beam focus gradually deviates in each path, and to prevent this, distances should be adjusted periodically. Through distance adjustment, processing performance may be optimized and material deformation may be minimized.

Further, in multi-path processing, laser pulses may repeatedly proceed with processing at the same points. In this case, the focusing states of laser beams gradually change, and phenomena of deviating from focus may occur. To solve this, by adjusting distances between the scanner 120 and materials at predetermined cycles, the focusing states of laser beams may be maintained consistently.

Further, when distances between the scanner 120 and materials are adjusted at predetermined periods in multi-path processing, the focusing states of laser beams are optimized to maintain accurate processing depth and uniform hole shapes. Accordingly, taper or processing imbalance may be prevented and high-precision processing may be realized.

As such, by adjusting distances, the focusing states of laser beams may be maintained constantly to ensure accurate processing depth and uniform shapes. Accordingly, material deformation or non-uniform hole shapes may be prevented. Further, taper is a problem that occurs when laser beams proceed with processing asymmetrically. Through distance adjustment, taper formation may be prevented and processed holes may be maintained with accurate depth and shapes. Further, problems occurring when deviating from focus may be solved, and material deformation or quality deterioration may be minimized through accurate laser focusing. This is an important factor that greatly enhances processing performance.

Therefore, distance adjustment is an essential factor for maintaining accuracy and processing quality in laser processing using Gaussian beams. In multi-path processing, by periodically adjusting distances between the scanner 120 and materials, processing performance may be optimized and taper or processing quality deterioration may be prevented. This method plays an important role in implementing precise laser processing and is necessary for maintaining high-speed yet high-quality perforation.

What has been described above is only one embodiment for implementing the porous support laser processing system according to the present invention, and the present invention is not limited to the embodiment. As claimed in the following patent claims, anyone with ordinary knowledge in the field to which this invention belongs may make various modifications within the scope that does not depart from the gist of the present invention, and the technical spirit of the present invention is present to the extent of such possible ranges of various modification implementations.

What is claimed is:

1. A porous support laser processing system comprising:
a laser source outputting a laser beam having a pulse repetition frequency;
a scanner receiving the laser beam from the laser source and reflecting and irradiating the laser beam to a porous support; and
a controller integrally controlling the laser source and the scanner, wherein the controller controls the laser source and the scanner such that the pulse repetition frequency of the laser source and a moving speed of the scanner are synchronized based on a ratio to form a plurality of holes with constant spacing, constant width, and constant depth in the porous support.

2. The porous support laser processing system of claim 1, further comprising a beam splitter, wherein the beam splitter distributes the laser beam received from the laser source to a plurality of paths and delivers the distributed laser beam to the scanner.

3. The porous support laser processing system of claim 1, further comprising a vision unit, wherein the vision unit captures a surface of the porous support in real-time, synthesizes the captured surface into a whole image, automatically adjusts a position such that a drilling pattern is aligned with a center of the support, and feeds back processing position and alignment information to the controller.

4. The porous support laser processing system of claim 1, further comprising a synchronization monitoring unit sensing a portion of the laser beam from each of the laser source and the scanner and monitoring the pulse repetition frequency of the laser source and the moving speed of the scanner in real-time, wherein the controller integrally controls the laser source, the scanner, and the synchronization monitoring unit, and controls the laser source and the scanner such that the pulse repetition frequency of the laser source and the moving speed of the scanner are synchronized based on a synchronization monitoring signal received from the synchronization monitoring unit.

5. The porous support laser processing system of claim 1, further comprising a processing monitoring unit, wherein the processing monitoring unit measures a hole processing depth and a hole shape of the porous support in real-time and feeds back the measured hole processing depth and hole shape to the controller.

6. The porous support laser processing system of claim 5, wherein the processing monitoring unit includes an optical coherence tomography (OCT) or a chromatic confocal device.

7. The porous support laser processing system of claim 5, wherein the controller controls the laser source and the scanner based on a feedback signal to make the processing depth of the hole and the shape of the hole constant.

8. The porous support laser processing system of claim 1, further comprising a suction jig unit, wherein the suction jig unit comprises:
a suction jig fixing the porous support;
a blower installed on one side of the suction jig and blowing away scattered particles generated during processing; and
a discharge unit installed on another side of the suction jig and sucking the scattered particles and discharging the scattered particles to an outside.

9. The porous support laser processing system of claim 1, wherein the controller controls the scanner to perform at least one of multi-path processing, processing direction, processing sequence, processing division, line spacing, and distance adjustment for the porous support,
wherein the multi-path processing is such that the controller controls the scanner to disperse energy of the laser beam to a work area and performs gradual etching through multiple paths to prevent material deformation,
wherein the processing direction is such that the controller controls a moving path of the scanner and a moving direction of the laser beam to increase processing efficiency through bi-directional or unidirectional scanning,
wherein the processing sequence is such that the controller sets a processing sequence of the scanner to a raster pattern or an interlacing scanning method to adjust processing speed and precision,
wherein the processing division is such that the controller equally divides a work area of the scanner into uniform area units to proceed with processing and reduces time required for movement of the scanner,
wherein the line spacing is such that the controller adjusts spacing between pulses of the laser beam by the laser source and spacing between lines by the scanner to adjust pattern density and changes a rectangular arrangement to a diamond or hexagonal pattern, and
wherein the distance adjustment is such that the controller periodically adjusts a distance between the scanner and the porous support when performing the multi-path processing to adjust a focus of a Gaussian beam.
